(19) United States
(12) Patent Application Publication
(10) Pub. No.: US 2007/0174818 A1
(43) Pub. Date: Jul. 26, 2007

(54) Method and apparatus for generating application programs for multiple hardware and/or software platforms

(76) Inventor: Markus I. Pasula, Helsinki (FI)

Correspondence Address: RealNetworks, Inc., PO Box 91123, Seattle, WA, 98111-9223, US

(21) Appl. No.: 11/265,784

(22) Filed: Nov. 1, 2005

Related U.S. Application Data
(60) Provisional application No. 60/711,039, filed on Aug. 18, 2005.

(51) Int. Cl. G06F 9/45

(52) U.S. Cl. 717/136

(57) ABSTRACT

Embodiments of methods, apparatuses, devices and systems associated with generating an executable program are disclosed.

This application claims the benefit pursuant to 35 U.S.C. 119 of U.S. Provisional Application No.______, Entitled METHOD AND APPARATUS FOR AUTOMATICALLY CREATING APPLICATION CODE FOR MULTIPLE PLATFORMS, and filed on Aug. 18, 2005, Attorney Docket No. 015.P005, incorporated herein by reference.

### BACKGROUND

Designing executable programs for use with handheld devices may involve writing a program for a particular handheld electronic device having particular hardware and/or a particular software platform. The executable program, under those circumstances may not function, or not function as well, with other handheld devices. A designer, or under some circumstances a software application, may have to modify the executable program, at least in part, so that the executable program may function, or function well, with different handheld devices.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 depicts a flow chart of a process of designing an application program;

FIG. 2 depicts a flow chart of a method in accordance with an embodiment;

FIG. 3 depicts a schematic diagram of a program generator in accordance with an embodiment;

FIG. 4 depicts a schematic diagram of a program profile in accordance with and embodiment; and

FIG. 5 depicts a schematic diagram of a target profile in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components and/or circuits that would be understood by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

“Instructions” as referred to herein relate to expressions which represent one or more logical operations. For example, instructions may be “machine-readable” by being interpretable by a machine for executing one or more operations on one or more data objects, such as, for example, a processor. However, this is merely an example of instructions and claimed subject matter is not limited in this respect. In another example, instructions as referred to herein may relate to encoded commands which are executable by a processor or other processing circuit having a command set which includes the encoded commands. Such an instruction may be encoded in the form of a machine language understood by the processor or processing circuit. Again, these are merely examples of an instruction and claimed subject matter is not limited in these respects. In this context, instructions may be organized into a software, shareware, freeware, firm ware, or combinations thereof. In addition, instructions may be organized into subroutines, objects, and/or combinations thereof, for example. An “object” as referred to herein relates to one or more executable instructions, which may be stored in a memory associated with a computing system and/or computing platform, along with one or more data units and/or portions of data, for example.

“Storage medium” as referred to herein relates to media capable of maintaining expressions which are perceivable by one or more machines. For example, a storage medium may comprise one or more storage devices for storing machine-readable instructions, information, and/or objects. Such storage devices may comprise any one of several media types including, for example, magnetic, optical and/or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based at least in part on one or more input signals. Such circuitry may comprise a finite state machine which receives a digital input signal and provides a digital output signal, or circuitry which provides one or more analog output signals in response to one or more analog input signals. Such circuitry may be provided, for example, in an application specific integrated circuit (ASIC) and/or a field programmable gate array (FPGA). Also, logic may comprise machine-readable instructions stored in a storage medium in combination with a processor or other processing circuitry to execute such machine-readable instructions. However, these are merely examples of structures which may provide logic and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “determining,” “generating,” “creating,” “merging,” “providing”, “querying,” “obtaining,”“representing,” “modifying,” “receiving,” “transmitting,” “storing,” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically. stated otherwise, a process as described herein, with reference to flow diagrams or otherwise, may also be executed and/or controlled, in whole or in part, by a computing platform. A “handheld electronic device” as referred to herein relates to an at least somewhat portable computing platform, such as a cellular telephone, a personal digital assistant, a portable music or video player, and/or a laptop computer for example, though of course claimed subject matter is not limited in this regard. A “device” as referred to herein relates to a computing platform which may be capable of executing one or more instructions, for example.

A “computer program,” an “application program,” and/or an “executable program” as referred to herein relates to an organized list of instructions that, if executed, results in or causes a computer, computing device, handheld electronic device, device, and/or machine to behave in a particular manner. Here, for example, an executable program may comprise machine-readable instructions that are executable to perform one or more desired tasks. In one embodiment, although claimed subject matter is not limited in this respect, a computer program may define input data and output data such that execution of the program may provide output data based, at least in part, on the input data. However, these are merely examples of a computer program and claimed subject matter is not limited in these respects.

An “application” as referred to herein relates to a computer program or group of computer programs capable of providing a result and/or action. In an embodiment, for example, such an application may comprise a program that performs desired tasks in conjunction with a handheld electronic device, although claimed subject matter is not limited in this respect. For example, an application may comprise one or more end-user programs, such as database programs, spreadsheet programs, word processor programs, and/or entertainment programs, that are accessible through a network browser, electronic mail, interactive games, video and/or image processing programs, calendars, financial application software, inventory control systems and/or the like. However, these are merely examples of an application and claimed subject matter is not limited in these respects.

“Stored data” as referred to herein relates to information stored in a storage medium in some retrievable format. An “indicator” as used herein relates to information that may represent one or more aspects of a program, a hardware and/or software platform, such as information that may be provided to a program generator, for example. A “software platform” as referred to herein with respect to a particular program or programs relates to one or more programs which may run on a target device, such that the particular program or programs may be capable of running on the target device along with the software platform such that data and/or instruction may be passed from the particular program or programs to the target device at least in part via the software platform. For example, a software platform may comprise an operating system and/or other software program which may provide an interface for an executable program, for example.

In one embodiment, a method for generation of executable programs, such as a game, for example, which may, under some circumstances be compiled with profiles entered by a designer so that the executable program may run on one or more target handheld electronic devices, for example, is disclosed. In one embodiment a program generator is disclosed witch may, under some circumstances, include an application program interface (API) for allowing a designer and/or programmer to create a program and generate an executable program compatible with one or more target hardware and/or software platforms, though, of course, claimed subject matter is not limited in this regard. By way of example, a software platform may comprise an operating system on a target device, such as a Java, a C, and/or a Windows based operating system which may provide an API for an executable program, though, of course, claimed subject matter is not limited in this regard. In one embodiment the API and programming commands may be used by a designer to create a program which may be configured and/or compiled, at least in part by the program generator, to run on any of a range of platforms by including one or more profiles associated with a particular hardware, and/or software platform associated with a handheld electronic device. In this context, and as discussed further below, the profiles may comprise one or more parameters associated with the handheld electronic device, though, again, claimed subject matter is not limited in this regard.

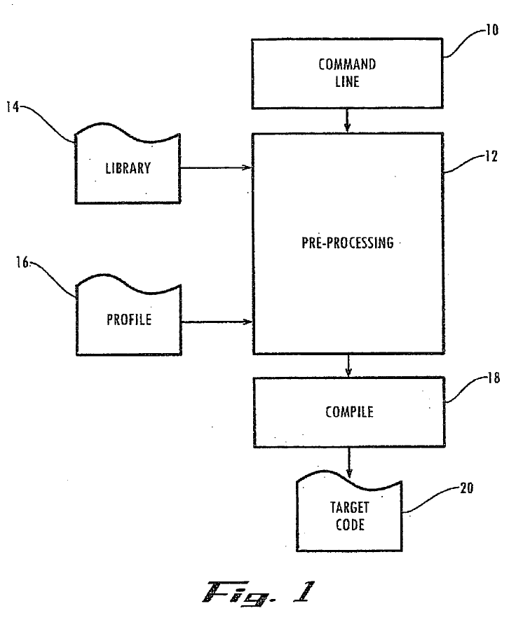

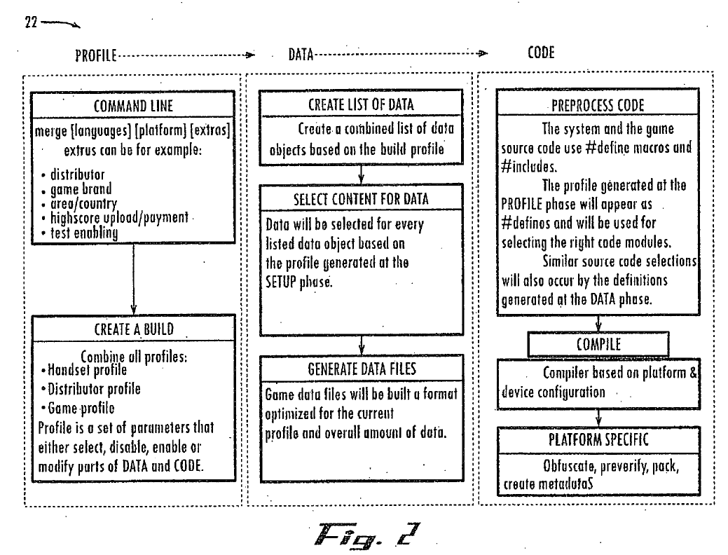

In one embodiment a program generator may comprise a pre-compiler, such as Java2 Standard Edition and/or C++, for example, a command line software program, a shell script software program, such as those provided at www.jpsoft.com, library files, systems made up of such devices, and methods of operations of these elements, devices and/or systems, and related subject matters. With reference to FIG. 1, an application program interface (API) and programming language having a syntax are created to form at least a portion of a program generator, discussed more fully below, as shown. With regard to box 10, a command line application, such as 4NT by JDsoft.com, for example processes source code corresponding to a designed executable program using a command line script, discussed more fully below with reference to FIG. 2, entered by a programmer such as a designer, though, of course, claimed subject matter is not limited in this regard. With regard to box 12, a pre-processing process may be applied to the source code using a pre-processing program, such as GCC from sourceforge.net, for example, though, of course, claimed subject matter is not limited to this illustrative example. In one embodiment pre-processing process 12 may, under some circumstances, receive input from a library 14 and/or a profile 16. By way of example, profile 16 may comprise information associated with a target device, such as a handheld electronic device. In an embodiment profile 16 may further comprise parameters associated with a target device such as those described below with reference to FIG. 2. For example, library 14 may comprise subroutines, objects, and/or and source code instructions that may be called, executed, and/or incorporated by pre-processing process 12. In one embodiment module 18 may compile the preprocessed code into target code 20. By way of example, target code 20 may comprise an executable program at least in part compatible with the targeted device.

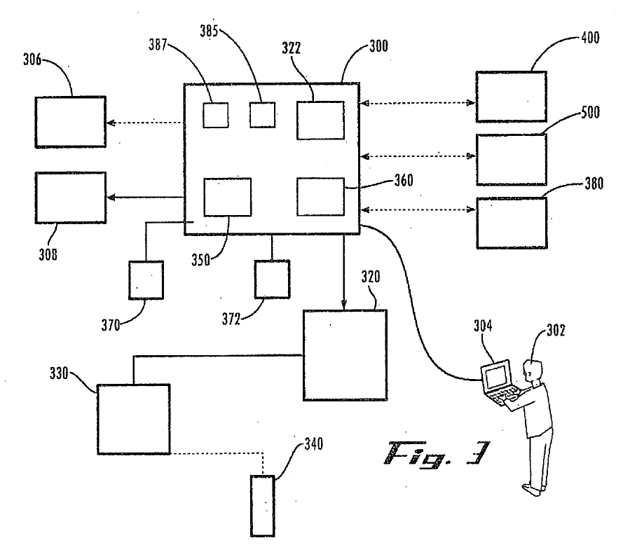

In an embodiment a program, such as a video game, for example, may be designed as to be compatible with a program generator (discussed below with regard to FIG. 3). For example, the program may be designed and/or written using various software languages, such as Java, and/or C, though of course claimed subject matter is not limited in this regard. With regard to the program generator, a profile 16 for one or more of target devices may be provided to, and/or selected by, the program generator. In an embodiment, profile 16 may comprise information such as a processor speed associated with the target device, a graphics capability associated with the target device, an indicator of sound capabilities associated with the target device, an input layout associated with the target device, a keyboard latency associated with the target device, and/or a memory capability associated with the target device, though, of course, claimed subject matter is not limited to these illustrative examples. In addition, profiles associated with additional devices may be added and/or incorporated into the program generator at any time, such as when a new device becomes available and/or additional devices are desired to be supported. With regard to box 22, the application program may then be compiled into an executable program compatible with the target device by the program generator as described more fully below. In should be noted that these are merely illustrative examples relating to program generators and that claimed subject matter is not limited in this regard.

By way of example, a user may specify a profile by entering a command line and creating a build of the designed application program. For example, the user may enter a command line instruction which may specify that the program generator is to be run. The user may also, in this example, specify the target device and, under some circumstances, one or more of the following: language of the target device, a distributor of the executable program, a brand to be associated with the executable program, area/country of the target product, high scores, payment information and/or test enabling functions. Though, again, it should be noted that this is merely an illustrative example and that claimed subject matter is not limited in this regard. At least in part in response to one or more of the user instructions an application program, or an intermediate program, may be generated which may comprise one or more of the following; a handset profile, a distributor profile, and/or a game profile. In an embodiment the profile may comprise a set of parameters which, under some circumstances may select, disable, enable and/or modify parts of the designer created data or code.

At least in part in response to the profile being entered, the program generator may create one or more data files which may comprise a list of target platform data objects, the content of which may be selected and which may correspond to one or more of the data objects.

In one embodiment, an execution program at least in part compatible with a target device may be generated at least in part by a pre-processing process, as described above, and/or a compiling process, as described above. Though, of course, it should be noted that this is merely an illustrative example relating to a program generator and that claimed subject matter is not limited in this regard. An application designer may determine which program profiles may be included in an executable program based at least in part on one or more parameters associated with a particular target device. In one embodiment the designer may include in the application program source code one or more instructions which may, under some circumstances, instruct the pre-processing process to select one or more modules which may correspond to a targeted device which may have been selected by way of a command line instruction, though claimed subject matter is not limited in this regard. In one embodiment the program generator may add source code to the application program under some circumstance, such as, for example, when an additional module may be needed to process a selected data source included in the application program. Once the pre-processing process has at least in part been completed, the generated code may be compiled based on the profile associated with the target device such as by using a compiler compatible with the target device, though, again, claimed subject matter is not limited in this regard. Additionally the compiled code may then be obfuscated, packed, pre-verified or platform specific metadata may be created.

With regard to FIG. 3, the program generator 300 may be initiated by a user input, such as a user 302 entering a command line instruction on a computing device 304, such as a computer which may be running program generator 300, and/or a computer that may be operably connected to a computing platform running program generator 300, for example. In one embodiment, the command line instructions may comprise a target device indicator, a display language indicator, and/or other parameters, although, again claimed subject matter is not limited in this regard. By way of example, the display language indicator may instruct program generator 300 as to which display language, such as English, Spanish, etc., to include in a generated executable program. In an embodiment, the target device indicator may describe a target handheld electronic device which the generated executable program should be compatible with. In an embodiment, the other parameters may be used to define any number of extra parameters for the generated executable program, such as a distributor of the executable application, a brand for the executable application, a build status or special version, or any of a number of other variables, including but not limited to those discussed below.

As discussed above, program generator 300 may create a build profile 306 based at least in part on one or more of the parameters from a command line instruction, for example. In addition, program generator 300 may create and/or form a resource list file 308 based at least in part on a portion of build profile 306 and/or parameters associated with build profile 306. In one embodiment resource list file 308 may comprise one or more indicators associated with one or more data objects which may be used by and/or incorporated into a generated executable program 320, though, of course, claimed subject matter is not limited in this regard. In an embodiment program generator 300 may additionally generate, create, and/or access one or more data objects and/or one or more portions of source code at least in part associated with the data object in response to one or more portions of build profile 306 and/or resource list file 308, for example. In an embodiment, program generator 300 may then pre-process source code based at least in part on build profile 306, resource list file 308, and/or generated data objects and/or associated source code, such as with a pre-processing program 322, for example. In addition, program generator 300 may generate, create, form, and/or compile executable program 320 based at least in part on the pre-processed source code, though, again, claimed subject matter is not limited in this regard. In an embodiment, program generator 300 may transfer executable program 320 into a final directory 330 for additional uses, such as transferring executable program 320 to a target handheld electronic device 340, for example.

Additional parameters which may be passed to program generator 300 may comprise one or more identifiers for executable program 320, such as an engine identifier, an application identifier, an application name, and/or an application abbreviation, for example. In one embodiment the engine identifier may comprise an indication of one or more portions of code that may be incorporated in some manner into executable program 320. In addition, an application identifier may comprise one or more identifiers which may describe the application program in a somewhat unique way, such that the application identifier may be used as a portion of file names associated with the application program. In an embodiment the application name may indicate a full name for executable application 320 as it may be displayed on handheld electronic device 340, for example. In addition, the abbreviated name may include an identifier which may indicate a particular storage area, such as a database, with which development of executable program 320 may be associated. Though, again, it should be noted that this is merely an illustrative example relating to a program generator and that claimed subject matter is not limited in this regard.

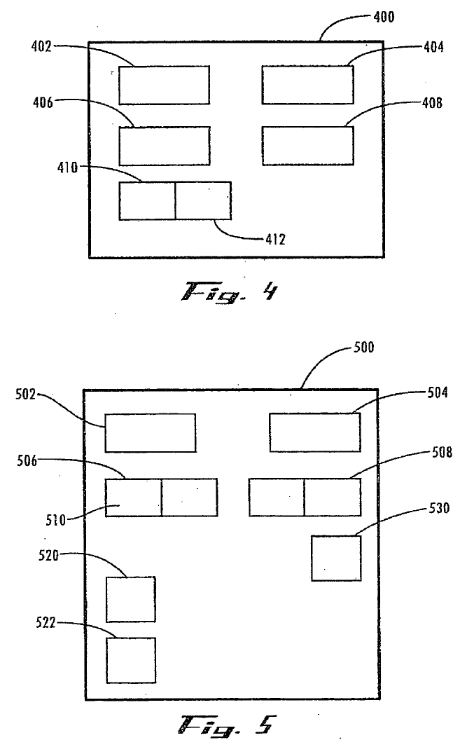

With regard to FIG. 4, a program profile 400 may comprise one or more sets of parameters, such as parameters 402 and/or 404, which may, under some circumstances, define a configuration of executable program 320. In one embodiment parameters 402 and/or 404 may comprise one or more instructions to program generator 300 to modify one or more portions of code associated with executable program 320. For example, parameters 402 and/or 404 may instruct program generator 300 to select, disable, enable, and/or otherwise modify one or more portions of data and/or code associated with executable program 320, though, again, claimed subject matter is not limited in this regard. In addition, parameters 402 and/or 404 may define one or more types of parameters, such as relatively definite parameter 406 and/or abstract parameter 408, for example. In one embodiment relatively definite parameter 406 may indicate, for example, that a particular color comprises a particular value or that a particular handheld electronic device 340 has a particular resolution, such as 240×320. It should be noted, of course, the above are just illustrative examples relating to relatively definite parameters and claimed subject matter is not limited in this regard. In one embodiment abstract parameter 408 may indicate, for example, that a particular handheld electronic device 340 comprises a relatively slow processor and/or may execute executable program 320 at a relatively slower speed than other handheld electronic devices or that a distributor of a particular handheld electronic device prefers that a splash screen be displayed if the executable program is started, to name but a few example of abstract parameters. Though, of course, it should be noted that this is merely an illustrative example relating to a program generator and that claimed subject matter is not limited in this regard. For example, program profile 400 may be used to define and/or configure any modules, such as from a library of modules, the program generator may use. In addition, the program profile may further comprise particular handheld electronic device adaptation information, such as a hardware and/or software platform specific configuration for executable program 320.

With regard to FIG. 5, a target profile 500 may comprise one or more stored parameters, such as parameter 502 and/or 504, which may be associated with a particular handheld electronic device 340. In addition, one or more parameters relating to a particular handheld electronic device 340 may be passed to program generator 300, for example, by user 302 , such as by entering the parameter through an interface, such as a command line interface as discussed above. In one embodiment target profile 500 may comprise one or more parameter/value pairs, such as parameter/value pairs 506 and/or 508, for example. In one embodiment parameter/value pair 506 may comprise one or more parameter indicated hardware limitations 510, such as a resolution class and paired value 512 may comprise a numeric value representing a particular value for hardware limitation 510, though, again, claimed subject matter is not limited in this regard. Target profile 500 may also comprise one or more parameters that are not paired with a particular value, such as parameters 520 and 522, for example. It should be noted that these are merely examples relating to parameters and that claimed subject matter is not limited in this regard.

In one embodiment target profile 500 may further comprise one or more characteristics of a handheld electronic device 340 supported by program generator 300. For example, the characteristics may comprise information such as screen resolution, resolution class, supported sound formats and/or other sound parameters, approximation of the number of characters that may fit comfortably on screen for one or more supported fonts, supported input devices, such as key pads, central processing unit speed, input latency, performance data, any external API support for a particular handheld electronic device, such as Bluetooth, M3G, for example, one or more predefined handheld electronic device specific parameters that may be used by program generator 300 to modify various implementation details of a generated executable program 320. Program generator 300 may. take one or more of these parameters into account when generating, and/or modifying executable program 320, for example.

In an embodiment, program generator 300 may, at least in part, transform the provided one or more parameters into one or more portions of the generated executable programs. In addition, program generator 300 may, at least in part, use target profile 500 and/or any provided parameters, such as parameters 502 and/or 504, to transform one or more portions of program profile 400 and/or one or more portions of executable program 320, though, of course, claimed subject matter is not limited in this regard.

In one embodiment, target profile 500 and/or program profile 400 may comprise one or more parameters which may be associated with one or more conditions, such a conditional parameters 410 and/or 530, for example, wherein one or more parameters may be paired with one or more conditions. For example, conditional parameter 410 may comprise one or more parameters witch may not be used by program generator 300 unless a condition 412 and/or 530, respectively have been satisfied. Conditions 412 and/or 530 may, under some circumstances, comprise a single value condition, a conditional logic statement, and/or any other type of condition, though claimed subject matter is not limited to these illustrative examples. In one embodiment, condition 412 may comprise a Boolean operative, for example.

In one embodiment program generator 300 may further comprise one or more modules for evaluating, reading, and/or writing to profiles, such as a profile parser 350, for example. For example, profile parser 350 may comprise a module or sub-routine capable of evaluating, such as sequentially, one or more portions of program profile 400, target profile 500, and/or any other profile associated with a particular executable program 320, though, again, claimed subject matter is not limited in this regard.

Program generator 300 may further comprise one or more program generator profiles, such as program generator profile 360. In this embodiment, program generator profile 360 may comprise information relating to a plurality of handheld electronic devices 340, a plurality of handheld electronic device distributors (not shown) in addition to parameters and/or module profiles compatible with a plurality of handheld electronic devices 340, and/or any additional information relating to one or more handheld electronic devices 340.

In one embodiment, program generator 300 may also generate executable program 320 based, at least in part, on one or more distributor profiles. A distributor profile may, for example, comprise one or more desired attributes for a generated executable program, such as a particular display when the executable program is launched, though of course claimed subject matter is not limited to this illustrative example.

In an embodiment, program generator 300 may incorporate one or more data objects into a generated executable program320. As referred to herein, data objects may comprise resources which may be used by program generator 300. For example, a data object 370 may comprise one or more graphics files, sound files, text files, and/or combinations thereof. Data object 370 which may be used in conjunction with a particular executable program 320 may be defined in resource list file 308 associated with executable program 320, for example.

In one embodiment, program generator 300 may create and/or modify resource list file 308 based at least in part on one or more of the parameters provided by program profile 400, target profile 500, and/or distributor profile 380, for example. In this embodiment, a resource list file 308 may comprise one or more groups and/or identifications of data object, such as data object 370 which may be used by program generator 300 in creating, modifying, and/or forming executable program 320, for example. Program generator 300 may, in one embodiment, map one or more of the provided parameters to one or more corresponding definition files and/or data objects, which may, at least in part, be used by program generator 300 to create executable program 320. Program generator 300 may organize the identification values into one or more groups which may be used to control loading of data objects into program generator 320, such as to ease loading and/or to split data files which may be too large to load all at once, for example. It should be noted that this is merely an illustrative example relating to a program generator, and that claimed subject matter is not limited in this regard.

In one embodiment resource list file 308 may comprise a list of data objects, such as data object 370, having one or more formats. For example, the data objects may comprise image graphics resource files, sound effect resource files, text resource files, input device mapping files, one or more binary objects, one or more menu elements, JAD/Manifest data, such as Jadstart, Jadmf, Jadend, Mfend, Mfstart, jmf Java descriptor metadata, data to insert to the start of a JAD file, data to append to the end of a JAD file, data to insert to the start of a MANIFEST file, data to insert to the end of a MANIFEST file, data to insert in the “body” of a JAD and/or a MANIFEST file.

In one embodiment, program generator 300 may interact with one or more data definition files, such as data definition file 372. Data definition file 372 may correspond to one or more data types which may be a portion of one or more resource lists files, for example. Data definition file 372 may comprise one or more rules and/or parameters, such as establishing an acceptable range of values for a data file, for example.

Program generator 300 may further comprise one or more application program interfaces (API), such as APIs 385 and/or 387, for example. In an embodiment, APIs 385 and/or 387 may comprise interfaces for interacting with other programs or objects, for example. In one embodiment program generator 300 may comprise respective APIs for one or more core functions, for interaction with program modules, and/or interaction with extras modules. In an embodiment core functions may comprise basic implementations of program generator 300. For example, core functions may include mechanisms for reading and writing data, data mechanisms for persistent data storage and retrieval, graphics mechanisms for loading and unloading groups of graphics to and from memory, one or more graphics routines, such as drawing geometric shapes, images, text, etc., input device functions relating to input devices which may be a part of an interface for the generated program, sound effects mechanisms for loading and unloading groups of sounds to and from memory, sound routines for sound playback, text mechanisms for loading and unloading groups of texts to and from memory.

In one embodiment, program modules, may comprise one or more files for defining particular functions of a generated executable program 320. For example, modules for implementing a menu interface, modules for implementing methods for handling any scores and/or other generated data tables, a commerce module which may, under some circumstance, be used to lock certain features of an executable program until a user has paid for the features, a textbox module which may be used to lay out text on screen in a rectangular area. The text can also contain horizontal alignment information, to name but a few examples. It should be noted that this is merely an illustrative example relating to program modules and, of course, that claimed subject matter is not limited in this regard. In this embodiment extras modules may comprise modules adapted for certain target hardware and/or software platforms, for example.

Designing an executable program 320 with program generator 300. may comprise providing one or more input instructions to program generator 300, for example. In one embodiment, executable program 320 may be designed independently of any target hardware and/or software platform, for example. In an embodiment target specific environment issues may be used to modify a designed executable program 320 in order to generate a target specific executable program 320, such as an executable program 320 adapted for a particular target device 340, for example. In an embodiment, an executable program 320 designed independently of a target device 340 may comprise one or more graphical aspects which may be scalable so that the one or more graphical aspects may be rendered on target devices 340 having different resolutions and hardware configurations, for example.

Executable program 320 generated by program generator 300 may, under some circumstances, be compatible with one or more target software platforms and/or target devices 340. In one embodiment, target software platforms may include JAVA based systems, such as J2ME, and/or C++ systems, such as BREW and/or Symbian, to name but a few examples.

Designing executable program 320 with program generator 300 may incorporate object oriented programming principles and/or other design principles, for example. In one embodiment objects may under some circumstances not include methods and/or may not be extendable, though this is merely an illustrative example and claimed subject matter is not limited in this regard. For example, in one embodiment objects may include strings, though, of course, claimed subject matter is not limited in this regard. In one embodiment objects may be passed to other objects as parameters, though, again, claimed subject matter is not limited in this regard.

It will, of course, also be understood that, although particular embodiments are described, claimed subject matter is not limited in scope to a particular embodiment or implementation. For example, one embodiment may be in hardware, such as implemented on a device or combination of devices, as previously described. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that if executed by a system, such as a computer system, computing platform, handheld electronic device, device, or other system, for example, may result in an embodiment of a method of manufacturing an apparatus, system, and/or executable program in accordance claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one or ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method comprising:
generating an executable program compatible with a handheld electronic device based at least in part on one of a plurality of software platforms associated with said handheld electronic device and based at least in part one or more instructions.

2. The method of claim 1, and wherein said one or more instructions and an indicator of the one of a plurality of software platforms are provided to a program generator.

3. The method of claim 2, wherein said plurality of software platforms comprise at least a JAVA compatible operating system and/or a C compatible operating system.

4. The method of claim 3, wherein said executable program comprises a game.

5. The method of claim 4, and further comprising transferring said game to a target handheld electronic device.

6. The method of claim 2, wherein said executable program is further generated based at least in part on one or more parameters associated with said handheld electronic device.

7. The method of claim 6, wherein said executable program comprises one or more instructions compatible with an application program interface, said application program interface chosen based at least in part on said one of a plurality of software platforms and/or said one or more parameters.

8. The method of claim 7, wherein generating said executable program comprises:
reading said one or more parameters, said indicator of said one of a plurality of software platforms, and/or the provided instructions; and
generating said one or more instructions compatible with said application program interface based at least in part on one of said one or more parameters, said indicator of said one of a plurality of software platforms, and/or the provided instructions.

9. The method of claim 6 and further comprising determining a display language for use by said executable program based at least in part on a provided display language indicator.

10. The method of claim 6, wherein said one or more parameters comprise a profile associated with said handheld electronic device.

11. The method of claim 10, wherein said profile comprises hardware and/or software platform information associated with said handheld electronic device.

12. The method of claim 11, wherein said profile further comprises one or more instructions to select, disable, and/or modify one or more of said instructions provided to said program generator.

13. The method of claim 11, wherein said profile further comprises a stored module including said hardware and/or software platform information associated with said handheld electronic device, wherein said stored module may be provided to said program generator.

14. An apparatus comprising:
a device capable of generating an executable program compatible with a handheld electronic device based at least in part on one of a plurality of software platforms associated with said handheld electronic device and at least in part on one or more instructions provided to said device.

15. The apparatus of claim 14, wherein an indicator of said one of a plurality of software platforms and said one or more instructions are provided to said device.

16. The apparatus of claim 15, wherein said plurality of software platforms comprise at least a JAVA compatible operating system and/or a C compatible operating system.

17. The apparatus of claim 16, wherein said executable program comprises a game.

18. The apparatus of claim 17, wherein said game is capable of being transferred to a target handheld electronic device.

19. The apparatus of claim 15, wherein said device is further capable of generating said executable program based at least in part on one or more parameters associated with said handheld electronic device.

20. The apparatus of claim 19, wherein said executable program comprises one or more instructions adapted for an application program interface, said application program interface chosen based at least in part on said one of a plurality of software platforms and/or said one or more parameters.

21. The apparatus of claim 20, wherein generating said executable program comprises:
reading said one or more parameters, said indicator of said one of a plurality of software platforms, and/or the provided instructions; and
generating said one or more instructions compatible with said application program interface based at least in part on one of said one or more parameters, said indicator of said one of a plurality of software platforms, and/or the provided instructions.

22. The apparatus of claim 20, wherein said device is further capable of determining a display language for use by said executable program based at least in part on a provided display language indicator.

23. The apparatus of claim 21, wherein said one or more parameters comprise a profile associated with said handheld electronic device.

24. The apparatus of claim 23, wherein said profile comprises hardware and/or software platform information associated with said handheld electronic device.

25. The apparatus of claim 24, wherein said profile further comprises one or more instructions to select, disable, and/or modify at least one of said one or more instructions provided to said device.

26. The apparatus of claim 25, wherein said profile further comprises a stored module including said hardware and/or software platform information associated with said handheld electronic device, wherein said stored module may be provided to said device.

27. An article comprising: a storage media having stored thereon instructions that if executed result in:
generating an executable program compatible with a handheld electronic device based at least in part on one of a plurality of software platforms associated with said handheld electronic device and at least in part on one or more instructions.

28. The article of claim 27, wherein said one or more instructions and an indicator of said one of a plurality of software platforms may be provided to a program generator.

29. The article of claim 28, wherein said plurality of software platforms comprises at least a JAVA compatible operating system and/or a C compatible operating system.

30. The article of claim 29, wherein said executable program comprises a game.

31. The article of claim 30, wherein said games is capable of being transferred to a target handheld device.

32. The article of claim 28, wherein said executable program is further generated based at least in part on one or more parameters associated with said handheld electronic device.

33. The article of claim 32, wherein said executable program comprises one or more instructions compatible with an application program interface, said application program interface chosen based at least in part on said one of a plurality of software platforms and/or based at least in part on said one or more parameters.

34. The article of claim 33, wherein generating said executable program comprises:
reading said one or more parameters, said indicator of said one of a plurality of software platforms, and/or the provided instructions; and
generating said one or more instructions compatible with said application program interface based at least in part on one of said one or more parameters, said indicator of said one of a plurality of software platforms, and/or the provided instructions.

35. The article of claim 32, and further comprising determining a display language for use by said executable program based at least in part on a provided display language indicator.

36. The article of claim 32, wherein said one or more parameters comprise a profile associated with a handheld electronic device.

37. The article of claim 36, wherein said profile comprises hardware and/or software platform information associated with said handheld electronic device.

38. The article of claim 37, wherein said profile further comprises one or more instructions to select, disable, and/or modify one or more of said instructions provided to said program generator.

39. The article of claim 37, wherein said profile further comprises a stored module including said hardware and/or software platform information associated with said handheld electronic device, wherein said stored module may be provided to said program generator.

40. A system comprising:
a profile means for storing information relating to hardware and/or software platforms associated with one or more handheld electronic devices;
a program generation means for generating an executable program compatible with one of said one or more handheld electronic devices.

41. An executable program comprising:
one or more program instructions compatible with a handheld electronic device and generated by a program generator based at least in part on one of a plurality of software platforms associated with said handheld electronic device and based at least in part on one or more instructions.

42. The executable program of claim 41, wherein said one or more instructions and an indicator of said one of a plurality of software platforms are provided to a program generator.

43. The executable program of claim 42, wherein said plurality of software platforms comprise at least a JAVA compatible operating system and/or a C compatible operating system.

44. The executable program of claim 43, wherein said executable program comprises a game.

45. The executable program of claim 44, wherein said game is capable of being transferred to a target handheld device.

46. The executable program of claim 42, wherein said one or more program instructions are further generated based at least in part on one or more parameters associated with said handheld electronic device.

47. The executable program of claim 46, wherein said one or more program instructions are compatible with an application program interface, said application program interface chosen based at least in part on said one of a plurality of software platforms and/or said one or more parameters.

48. The executable program of claim 47, wherein said one or more program instructions are further generated by:
reading said one or more parameters, said indicator of said one of a plurality of software platforms, and/or the provided instructions; and generating said one or more instructions compatible with said application program interface based at least in part on one of said one or more parameters, said indicator of said one of a plurality of software platforms, and/or the provided instructions.
